(19) United States
(12) Patent Application Publication
(10) Pub. No.: US 2023/0012237 A1
(43) Pub. Date: Jan. 12, 2023

(54) Bicycle Locking Device

(71) Applicant: Satu Terian, Carmel, CA (US)

(72) Inventor: Satu Terian, Carmel, CA (US)

(21) Appl. No.: 17/370,309

(22) Filed: Jul. 8, 2021

(51) Int. Cl. B62H 5/00; B62H 5/20; E05B 67/00; E05B 45/00; G07C 9/00

(52) U.S. Cl. CPC B62H 5/003; B62H 5/20; E05B 67/003; E05B 45/005; G07C 9/00563

(57) ABSTRACT

A bicycle locking device for securing a bicycle to a stationary object includes a housing, which defines an interior space. A cable is positioned in the interior space and has a first terminus, which is engaged to the housing. The cable is selectively extensible through a hole positioned in the housing. The cable is insertable through at least one element of an item, such as bicycle, and around a stationary object, so that a second terminus of the cable reaches the housing. A locking unit is engaged to the housing and selectively engages the second terminus the cable to secure the item to the stationary object. A biometric authenticator is engaged to the housing and is operationally engaged to the locking unit. The biometric authenticator authenticates a physiological characteristic of a user, positioning the biometric authenticator to signal the locking unit to release the cable.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to locking devices and more particularly pertains to a new locking device for securing a bicycle to a stationary object. The present invention discloses a locking device for a bicycle comprising a retractable cable positioned within a housing, wherein the cable can be positioned through one or more of a front wheel, frame, and rear wheel of the bicycle, around a stationary object, and locked to the housing. A detector engaged to the housing is configured to detect tampering and to initiate an alarm. A fingerprint scanner engaged to the housing is configured to authentic a fingerprint of a user prior to unlocking the cable from the housing.

### (2) Description of Related Art including information disclosed under 37 CFR 1.97 and 1.98

The prior art relates to locking devices, and in particular locking device for bicycles. While example of retractable locking device are found in the prior art, they do no include a detector configured to detect tampering and to initiate an alarm, nor a fingerprint scanner engaged to the housing and configured to authentic a fingerprint of a user prior to unlocking locking device.

### BRIEF SUMMARY OF THE INVENTION

An embodiment of the disclosure meets the needs presented above by generally comprising a housing, which defines an interior space. A cable is positioned in the interior space and has a first terminus, which is engaged to the housing. The cable is selectively extensible through a hole positioned in the housing. The cable is configured to be inserted through at least one element of an item and around a stationary object so that a second terminus of the cable reaches the housing. A locking unit is engaged to the housing and is configured to selectively engage the second terminus the cable so that the locking unit and the cable are configured to secure the item to the stationary object. A biometric authenticator is engaged to the housing and is operationally engaged to the locking unit. The biometric authenticator is configured to authenticate a physiological characteristic of a user, positioning the biometric authenticator to signal the locking unit to release the cable.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a bicycle locking device according to an embodiment of the disclosure.

FIG. 2 is an end view of an embodiment of the disclosure.

FIG. 3 is a back view of an embodiment of the disclosure.

FIG. 4 is a front view of an embodiment of the disclosure.

FIG. 5 is a detail view of an embodiment of the disclosure.

FIG. 6 is a side view of an embodiment of the disclosure.

FIG. 7 is a block diagram view of an embodiment of the disclosure.

FIG. 8 is an in-use view of an embodiment of the disclosure.

### DETAILED DESCRIPTION OF THE INVENTION

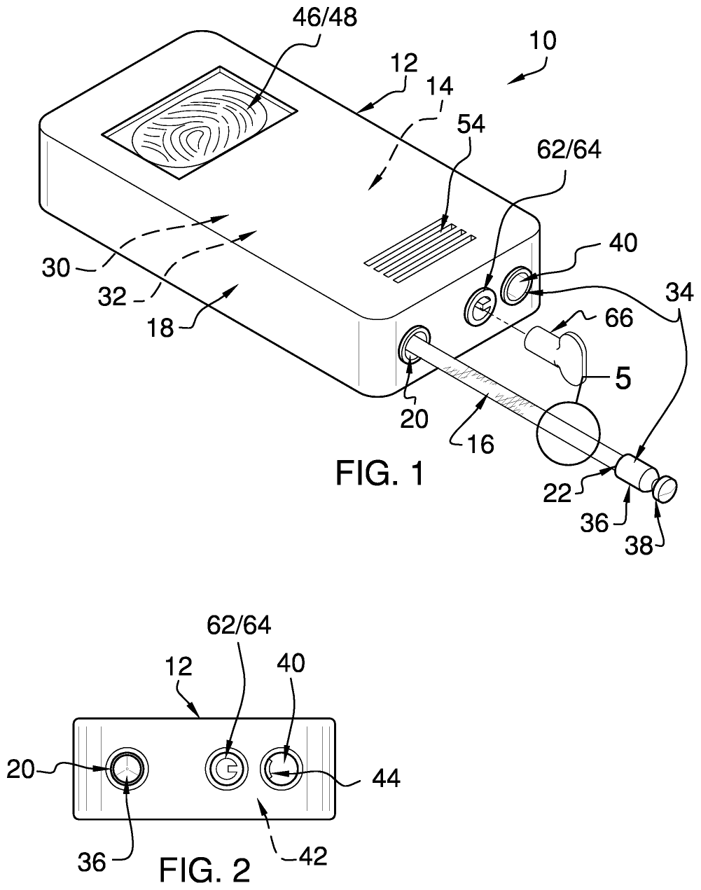

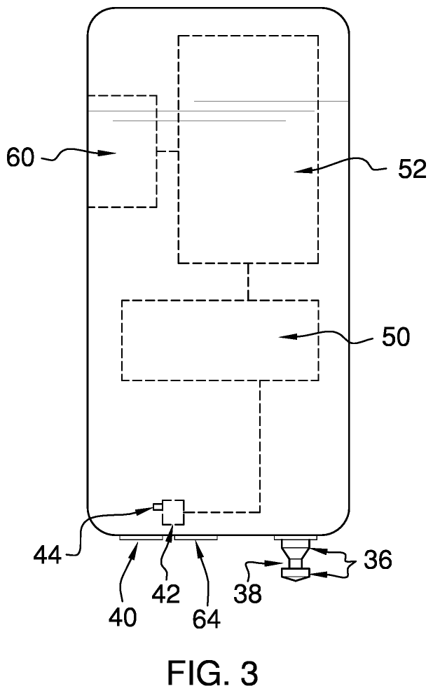

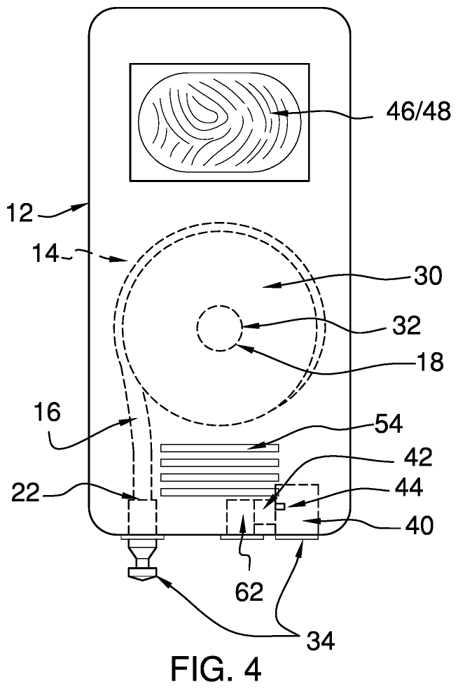

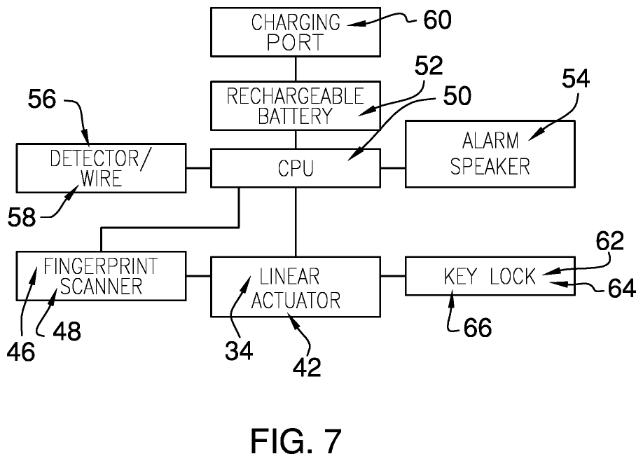

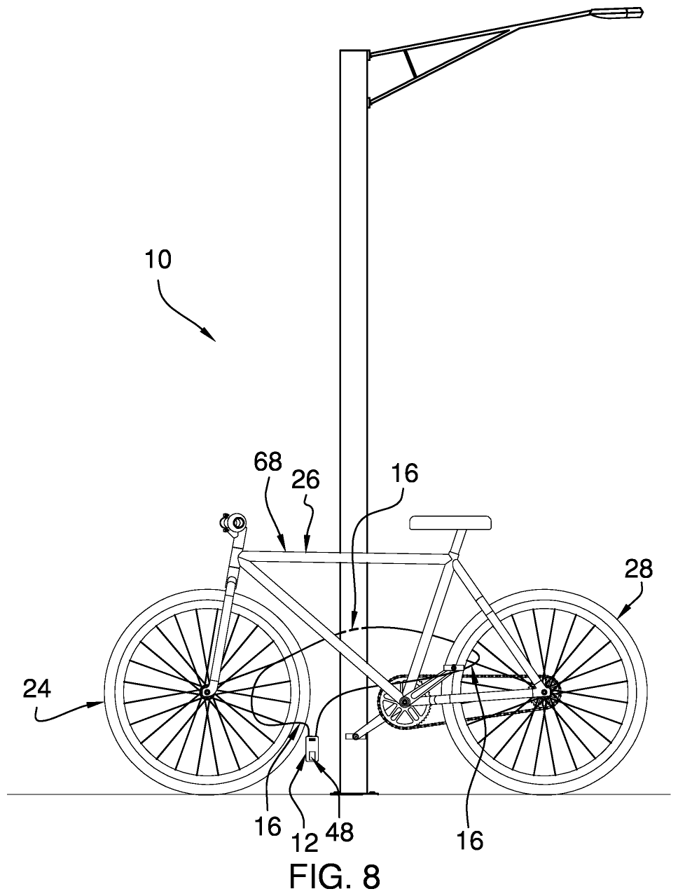

With reference now to the drawings, and in particular to FIGS. 1 through 8 thereof, a new locking device embodying the principles and concepts of an embodiment of the disclosure and generally designated by the reference numeral 10 will be described.

As best illustrated in FIGS. 1 through 8, the bicycle locking device 10 generally comprises a housing 12, which defines an interior space 14. The housing 12 may be disc shaped or cuboid shaped. A cable 16 is positioned in the interior space 14 and has a first terminus 18, which is engaged to the housing 12. The cable 16 is selectively extensible through a hole 20 positioned in the housing 12. The cable 16 is configured to be inserted through at least one element of an item and around a stationary object so that a second terminus 22 of the cable 16 reaches the housing 12. Examples of stationary objects include bike racks, posts, utility poles, trees, fences, and the like.

The cable 16 is long enough to extend from the housing 12, through a front wheel 24, a frame 26, and a rear wheel 28 of a bicycle 68, around the stationary object, and back to the housing 12. The present invention anticipates the housing 12 being sized such that it is readily insertable into a pocket, a saddlebag, and the like. Prior art bicycle locking devices generally comprise bulky cables or bulky chains, which render them inconvenient and less likely to be utilized.

A reel 30 is engaged to the housing 12 and positioned in the interior space 14. The cable 16 is loopedly positioned around the reel 30. A spring 32 is engaged to the housing 12 and the reel 30 so that the spring 32 is tensioned as the cable 16 is extended. The spring 32 is positioned to rebound to rotate the reel 30 to retract the cable 16 into the housing 12.

A locking unit 34 is engaged to the housing 12 and is configured to selectively engage the second terminus 22 the cable 16 so that the locking unit 34 and the cable 16 are configured to secure the item to the stationary object. The locking unit 34 comprises a barrel 36, which is engaged to the second terminus 22 of the cable 16. A groove 38 extends into and circumferentially around the barrel 36. A recess 40 extends into the housing 12 and is complementary to the barrel 36. A linear actuator 42 is engaged to the housing 12 and is positioned in the interior space 14. A piston 44 of the linear actuator 42 is positioned for selective insertion into the groove 38 to fixedly engage the barrel 36 to the housing 12 so that the item is secured to the stationary object.

A biometric authenticator 46 is engaged to the housing 12 and is operationally engaged to the locking unit 34. The biometric authenticator 46 is configured to authenticate a physiological characteristic of a user, positioning the biometric authenticator 46 to signal the locking unit 34 to release the cable 16. The biometric authenticator 46 may comprise a fingerprint scanner 48, or other authentication means, such as, but not limited to, facial recognition, voice recognition, iris recognition, and retina recognition.

A microprocessor 50 and a battery 52 are engaged to the housing 12 and are positioned in the interior space 14. The battery 52, the biometric authenticator 46, and the linear actuator 42 are operationally engaged to the microprocessor 50. A speaker 54 and a detector 56 are engaged to the housing 12 and are operationally engaged to the microprocessor 50. The detector 56 is operationally engaged to one or both of the cable 16 and the housing 12 and is configured to detect tampering with one or both of the cable 16 and the housing 12 and to signal the microprocessor 50 of the tampering. The microprocessor 50 then is positioned to actuate the speaker 54 to broadcast an alarm, such as a high decibel, high frequency squeal.

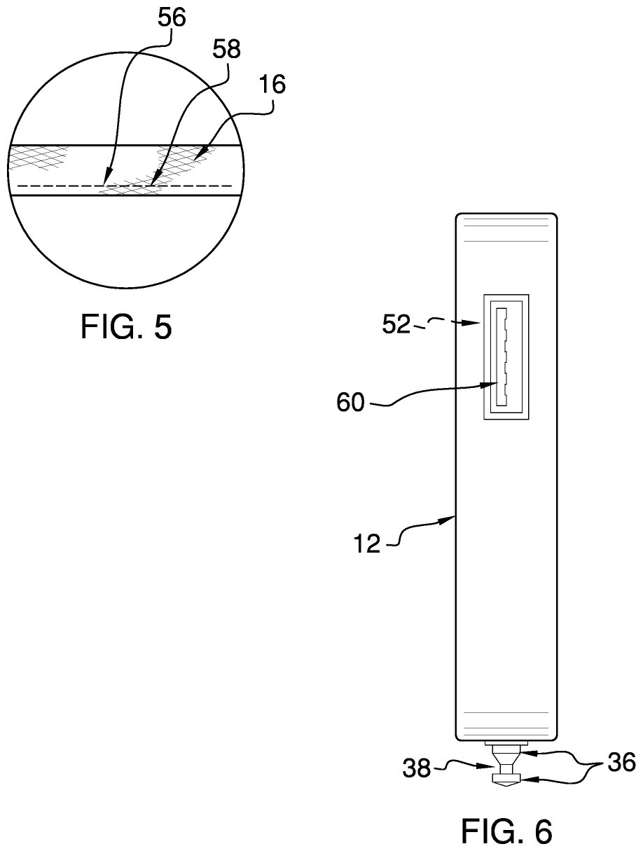

The detector 56 may be configured to detect termination of a current running through a wire 58 imbedded in the cable 16, as shown in FIG. 5. The present invention also anticipates the detector 56 being configured to detect movement of the housing 12, vibration of the cable 16, or motion proximate to the housing 12.

The battery 52 is rechargeable. A port 60 is engaged to the housing 12 and is operationally engaged to the battery 52. The port 60 is configured for insertion of a plug of a charging cable 16 (not shown) to operationally engage the battery 52 to a source of electrical current to charge the battery 52.

A lock 62 is engaged to the housing 12 and is configured to selectively engage the barrel 36. The lock 62 may be operationally engaged to the linear actuator 42 and thus positioned to engage the piston 44 selectively and mechanically to the barrel 36. The lock 62 may comprise a tubular pin tumbler lock 64 or other locking means known to those skilled in the art of locks. The bicycle locking device 10 also comprises a key 66 complementary to the lock 62. The key 66 is positioned to selectively lock and unlock the cable 16. The lock 62 and the key 66 provide an alternative means of securing the barrel 36 to the housing 12.

In use, the bicycle 68 is parked proximate to a stationary object and the cable 16 is inserted through the front wheel 24, the frame 26, and the rear wheel 28 of the bicycle 68. The cable 16 then is extended around the stationary object and the barrel 36 is inserted into the recess 40. The piston 44 of the linear actuator 42 inserts into the groove 38 to secure the barrel 36 to the housing 12 and the bicycle 68 to the stationary object. To unlock the bicycle 68, the user places their finger on the fingerprint scanner 48. Upon authentication of the fingerprint, the microprocessor 50 actuates the linear actuator 42 to retract the piston 44 from the groove 38. Should a person try to severe the cable 16, the detector 56 would signal the microprocessor 50 to actuate the speaker 54 to broadcast an alarm, thus deterring theft of the bicycle 68. The present invention is anticipated to be useful not only to bicyclists, but also to operators of mopeds, scooters, motorcycles, and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bicycle locking device comprising:
a housing defining an interior space;
a cable positioned in the interior space and having a first terminus engaged to the housing, the cable being selectively extensible through a hole positioned in the housing, wherein the cable is configured for inserting through at least one element of an item and around a stationary object, such that a second terminus of the cable reaches the housing;
a locking unit engaged to the housing and being configured for selectively engaging the second terminus the cable, wherein the locking unit and the cable are configured for securing the item to the stationary object; and
a biometric authenticator engaged to the housing and being operationally engaged to the locking unit, wherein the biometric authenticator is configured for authenticating a physiological characteristic of a user, positioning the biometric authenticator for signaling the locking unit for releasing the cable.

2. The bicycle locking device of claim 1, wherein the housing is disc shaped or cuboid shaped.

3. The bicycle locking device of claim 1, wherein the cable is long enough to extend from the housing, through a front wheel, a frame, and a rear wheel of a bicycle, around the stationary object, and back to the housing.

4. The bicycle locking device of claim 1, wherein the locking unit comprises:
a barrel engaged to the second terminus of the cable;
a groove extending into and circumferentially around the barrel;
a recess extending into the housing and being complementary to the barrel; and
a linear actuator engaged to the housing and positioned in the interior space, such that a piston of the linear actuator is positioned for selective insertion into the groove for fixedly engaging the barrel to the housing, such that the item is secured to the stationary object.

5. The bicycle locking device of claim 1, further including:
a reel engaged to the housing and positioned in the interior space, the cable being loopedly positioned around the reel; and
a spring engaged to the housing and the reel, such that the spring is tensioned as the cable is extended, such that the spring is positioned for rebounding for rotating the reel for retracting the cable into the housing.

6. The bicycle locking device of claim 1, wherein the biometric authenticator comprises a fingerprint scanner.

7. The bicycle locking device of claim 1, further including:
a microprocessor engaged to the housing and positioned in the interior space;
a battery engaged to the housing and positioned in the interior space, the battery being operationally engaged to the microprocessor;
a speaker engaged to the housing and being operationally engaged to the microprocessor; and
a detector engaged to the housing and being operationally engaged to the microprocessor and to one or both of the cable and the housing, the detector being configured for detecting tampering with one or both of the cable and the housing and for signaling the microprocessor, positioning the microprocessor for actuating the speaker for broadcasting an alarm.

8. The bicycle locking device of claim 7, further including:
the battery being rechargeable; and
a port engaged to the housing and being operationally engaged to the battery, wherein the port is configured for insertion of a plug of a charging cable for operationally engaging the battery to a source of electrical current for charging the battery.

9. The bicycle locking device of claim 7, wherein the detector is configured for detecting termination of a current running through a wire imbedded in the cable.

10. The bicycle locking device of claim 4, further including:
a lock engaged to the housing and being configured for selectively engaging the barrel; and
a key complementary to the lock, such that the key is positioned for selectively locking and unlocking the cable.

11. The bicycle locking device of claim 10, wherein the lock is operationally engaged to the linear actuator for selectively mechanically engaging the piston to the barrel.

12. The bicycle locking device of claim 10, wherein the lock comprises a tubular pin tumbler lock.

13. A bicycle locking system comprising:
a bicycle;
a housing defining an interior space;
a cable positioned in the interior space and having a first terminus engaged to the housing, the cable being selectively extensible through a hole positioned in the housing, the cable is being inserted through one or more of a front wheel, a frame, and a rear wheel of the bicycle, wherein the cable is configured for positioning around a stationary object, such that a second terminus of the cable reaches the housing;
a locking unit engaged to the housing and being configured for selectively engaging the second terminus the cable, wherein the locking unit and the cable are configured for securing the item to the stationary object; and
a biometric authenticator engaged to the housing and being operationally engaged to the locking unit, wherein the biometric authenticator is configured for authenticating a physiological characteristic of a user, positioning the biometric authenticator for signaling the locking unit for releasing the cable.

14. The bicycle locking system of claim 13, wherein the cable is long enough to extend from the housing, through the front wheel, the frame, and the rear wheel of the bicycle, around the stationary object, and back to the housing.

15. The bicycle locking system of claim 13, wherein the locking unit comprises:
a barrel engaged to the second terminus of the cable;
a groove extending into and circumferentially around the barrel;
a recess extending into the housing and being complementary to the barrel;
a linear actuator engaged to the housing and positioned in the interior space, such that a piston of the linear actuator is positioned for selective insertion into the groove for fixedly engaging the barrel to the housing, such that the item is secured to the stationary object;
a lock engaged to the housing and being configured for selectively engaging the barrel; and
a key complementary to the lock, such that the key is positioned for selectively locking and unlocking the cable.

16. The bicycle locking system of claim 13, further including:
a reel engaged to the housing and positioned in the interior space, the cable being loopedly positioned around the reel; and
a spring engaged to the housing and the reel, such that the spring is tensioned as the cable is extended, such that the spring is positioned for rebounding for rotating the reel for retracting the cable into the housing.

17. The bicycle locking system of claim 13, wherein the biometric authenticator comprises a fingerprint scanner.

18. The bicycle locking system of claim 13, further including:
a microprocessor engaged to the housing and positioned in the interior space;
a battery engaged to the housing and positioned in the interior space, the battery being operationally engaged to the microprocessor, the battery being rechargeable;
a port engaged to the housing and being operationally engaged to the battery, wherein the port is configured for insertion of a plug of a charging cable for operationally engaging the battery to a source of electrical current for charging the battery;
a speaker engaged to the housing and being operationally engaged to the microprocessor; and
a detector engaged to the housing and being operationally engaged to the microprocessor and to one or both of the cable and the housing, the detector being configured for detecting tampering with one or both of the cable and the housing and for signaling the microprocessor, positioning the microprocessor for actuating the speaker for broadcasting an alarm.

19. The bicycle locking system of claim 18, wherein the detector is configured for detecting termination of a current running through a wire imbedded in the cable.

20. A bicycle locking device comprising:
a housing defining an interior space, the housing being disc shaped or cuboid shaped;
a cable positioned in the interior space and having a first terminus engaged to the housing, the cable being selectively extensible through a hole positioned in the housing, wherein the cable is configured for inserting through at least one element of an item and around a stationary object, such that a second terminus of the cable reaches the housing, the cable being long enough to extend from the housing, through a front wheel, a frame, and a rear wheel of a bicycle, around the stationary object, and back to the housing;
a locking unit engaged to the housing and being configured for selectively engaging the second terminus the cable, wherein the locking unit and the cable are configured for securing the item to the stationary object, the locking unit comprising:
a barrel engaged to the second terminus of the cable,
a groove extending into and circumferentially around the barrel,
a recess extending into the housing and being complementary to the barrel, and
a linear actuator engaged to the housing and positioned in the interior space, such that a piston of the linear actuator is positioned for selective insertion into the groove for fixedly engaging the barrel to the housing, such that the item is secured to the stationary object;
a reel engaged to the housing and positioned in the interior space, the cable being loopedly positioned around the reel;
a spring engaged to the housing and the reel, such that the spring is tensioned as the cable is extended, such that the spring is positioned for rebounding for rotating the reel for retracting the cable into the housing;
a biometric authenticator engaged to the housing and being operationally engaged to the locking unit, wherein the biometric authenticator is configured for authenticating a physiological characteristic of a user, positioning the biometric authenticator for signaling the locking unit for releasing the cable, the biometric authenticator comprising a fingerprint scanner;
a microprocessor engaged to the housing and positioned in the interior space;
a battery engaged to the housing and positioned in the interior space, the battery being operationally engaged to the microprocessor, the battery being rechargeable;
a port engaged to the housing and being operationally engaged to the battery, wherein the port is configured for insertion of a plug of a charging cable for operationally engaging the battery to a source of electrical current for charging the battery;
a speaker engaged to the housing and being operationally engaged to the microprocessor;
a detector engaged to the housing and being operationally engaged to the microprocessor and to one or both of the cable and the housing, the detector being configured for detecting tampering with one or both of the cable and the housing and for signaling the microprocessor, positioning the microprocessor for actuating the speaker for broadcasting an alarm, the detector being configured for detecting termination of a current running through a wire imbedded in the cable;
a lock engaged to the housing and being configured for selectively engaging the barrel, the lock being operationally engaged to the linear actuator for selectively mechanically engaging the piston to the barrel, the lock comprising a tubular pin tumbler lock; and
a key complementary to the lock, such that the key is positioned for selectively locking and unlocking the cable.
